(19) United States
(12) Patent Application Publication
(10) Pub. No.: US 2024/0413371 A1
(43) Pub. Date: Dec. 12, 2024

(54) REGENERATION OF SYMMETRICAL NONAQUEOUS ORGANIC REDOX FLOW BATTERIES

(71) Applicant: ARIZONA BOARD OF REGENTS ON BEHALF OF THE UNIVERSITY OF ARIZONA, Tuscon, AZ (US)

(72) Inventors: Thomas Gianetti, Tucson, AZ (US); Jules Moutet, Tucson, AZ (US)

(73) Assignee: ARIZONA BOARD OF REGENTS ON BEHALF OF THE UNIVERSITY OF ARIZONA, Tuscon, AZ (US)

(21) Appl. No.: 18/812,156

(22) Filed: Aug. 22, 2024

Related U.S. Application Data
(63) Continuation of application No. PCT/US2023/013670, filed on Feb. 23, 2023.
(60) Provisional application No. 63/314,700, filed on Feb. 28, 2022.

(51) Int. Cl. H01M 8/18; H01M 8/0289

(52) U.S. Cl. CPC H01M 8/188; H01M 8/0289; H01M 2300/0025

(57) ABSTRACT

A method of regenerating a symmetrical redox flow battery includes: a first discharge process having a duration in which a capacity of the redox flow battery in a first polarity and comprising a membrane decreases from a first to a second capacity, the process comprising: flowing a catholyte through a catholyte compartment in the first polarity; flowing an anolyte through an anolyte compartment in the first polarity; wherein: the first polarity of the redox flow battery includes a membrane having a first face in fluid communication with the catholyte compartment and a second face in fluid communication with the anolyte compartment; and the first and the second faces of the membrane being opposing surfaces of the membrane; and a second discharge process comprising: reversing the polarity of the catholyte and anolyte compartments wherein: the redox flow battery in the second polarity exhibits an initial increased capacity compared to the second capacity from the first discharge process.

### CROSS REFERENCE TO RELATED APPLICATIONS

This application is a continuation of PCT/US2023/013670, filed on Feb. 23, 2023, which claims the benefit of priority to U.S. Provisional Patent Application No. 63/314,700 filed Feb. 28, 2022, both of which are hereby incorporated by reference in their entireties.

### FIELD

This technology relates to redox flow batteries. More particularly, this technology relates to organic redox flow batteries utilizing conjugated heterocyclic carbenium compounds as the catholyte and anolyte.

### BACKGROUND

In the context of economically and ecologically dynamics, energy production and storage deserve particular attention. After many years of intensive use of coal and oil combustion as main energy sources, humanity is increasingly oriented towards the use of electricity. Efficient storage of electricity-compatible with various applications-remains a challenge. Lithium ion-based battery, long dedicated to smartphones and small devices, has been a potential short-term solution. Their use in bigger applications, such as in the car industry, could lead to a scarcity of their raw materials (Li, Co, rare-earth), and result in a very significant increase of cost.

To overcome this problem and prepare for the future, several sustainable approaches have been considered in the Energy Storage Systems (ESSs) field. One of them is the development of redox flow batteries (RFBs). The energy is stored in liquid electrolyte solutions which flow through a battery of electrochemical cells during charge and discharge. The “redox” term refers to chemical reduction and oxidation reactions involved.

These redox flow batteries have several advantages over previously presented systems. Power conversion is separated from energy storage, thus allowing for independent power and energy sizing. This separation from energy storage allows for virtually unlimited ESS capacity and are only limited by the tanker size and the electrolyte concentration. In redox flow battery systems, the redox reactions are totally reversible, meaning that the same cell is used to operate as converter of electricity into chemical energy and vice-versa. From an infrastructure point of view, the redox flow battery system is relatively easy to develop. The setup requires only two tanks each provided with a pump and a cell provided with an ion exchange membrane between two electrodes. Therefore, redox flow battery systems have very few wear parts, and the equipment maintenance costs are extremely reduced. Lastly, there is a clear separation between the two electrolyte storage, which prevents self-discharge and the battery lifetime is mainly chemically dependent.

However, there are several points concerning redox flow battery systems that remain to be improved. Currently the energy density provided by the RFBs is insufficient for mobile applications. Parameters such as solubility and temperature of electrolytes remain crucial. Also, the cost of these EESs remains high due to their poor presence in the energy market.

Historically, the RFB systems was first used in France in 1933 with a Vanadium-based electrolyte. Today, vanadium RFBs still are the most marketed flow batteries, due to a number of advantages they present on other chemistries (V at both electrodes, no cross-contamination issues, and water-based solution). However, vanadium is costly, and these vanadium-based RFBs have a relatively low energy density. Furthermore, the capital cost of a vanadium-based RFB is attributed to the cost of the membrane materials, which are used to prepare the exchange membrane that separates the two poles of the battery. Such membranes are developed to be permeable only to anions, and are based on cationic functionalized polymers. This type of material is subjected to significant electrical charge stress over time, which impacts the longevity of the RFB. While metal coordination complexes appeared to be the most stable electrolyte, the critical technical and economic limitations associated with these complexes, such as low solubility, inferior electrochemical activity, and high costs, have motivated researchers to explore cheaper and easier to synthesize compounds.

Redox-active organic materials (ROMs) are a promising alternative option for improving current RFB systems as ROMs have: I) the molecular diversity, II) structural tailorability, and III) natural abundance that make them electrolytes of choice. Thus, there have been several RFB systems developed with redox-active organic materials. An important feature of these RFB systems is a one nitrogen-containing aromatic scaffold that is very soluble and highly tunable. However, the most known redox-active organic based RFB system still lacks high efficiency, robustness, and a large open circuit potential (OCV). This disclosure addresses the need for improved redox-active organic material based RFB systems.

### SUMMARY

The present technology provides methods for regenerating redox flow battery systems comprising conjugated heterocyclic carbenium compounds as both the anolyte and catholyte (symmetric organic redox flow batteries (SORFB). Specifically, the efficiency of the electrolyte may be regained by simply cycling the battery under reverse polarization. Also, the redox flow battery systems provide an opportunity to improve the properties of the exchange membrane (EM) that separates the two poles of the battery by allowing for a simple porous exchange membrane (EM), where the pore size of the EM provides selectivity based on size exclusion, may be used instead of an anion-selective membrane. In particular, a simple porous exchange membrane (EM), where the pore size of the EM provides selectivity based on size exclusion, may be used instead of an anion-selective membrane.

The use of the conjugated heterocyclic carbenium compounds as both the anolyte and catholyte also allows for the development of a symmetric organic redox flow battery (SORFB). This also provides for an opportunity to improve the properties of the exchange membrane (EM) that separates the two poles of the battery and overcome the limitations associated with vanadium-based RFBs as mentioned above. In particular a simple porous exchange membrane (EM), where the pore size of the EM provides selectivity based on size exclusion, may be used instead of an anion-selective membrane.

Provided in one aspect is a method of regenerating a symmetrical redox flow battery, the method including:
a first discharge process having a duration in which a capacity of the redox flow battery in a first polarity and including a membrane decreases from a first capacity to a second capacity, the process including:
   flowing a catholyte through a catholyte compartment of the redox flow battery in the first polarity;
   flowing an anolyte through an anolyte compartment of the redox flow battery in the first polarity;
   wherein:
      the first polarity of the redox flow battery includes the membrane having a first face in fluid communication with the catholyte compartment and a second face in fluid communication with the anolyte compartment; and
      the first and the second faces of the membrane being opposing surfaces of the membrane; and
a second discharge process including:
   reversing the polarity of the catholyte and anolyte compartments to a second polarity with respect to the membrane, such that the catholyte compartment is in fluid communication with the second face of the membrane, and the anolyte compartment is in fluid communication with the first face of the membrane; and
   flowing the catholyte through the catholyte compartment of the redox flow battery in the second polarity; and
   flowing the anolyte through the anolyte compartment of the redox flow battery in the second polarity;
   wherein:
      the redox flow battery in the second polarity exhibits an initial increased capacity compared to the second capacity from the first discharge process.

In some embodiments, after determining a reduction in capacity during the second discharge process, reversing the second polarity to a third polarity, which is the same as the first polarity with respect to the catholyte and anolyte compartment, and subjecting the redox flow battery to a third discharge process where the initial capacity of the third discharge process is greater than the reduced capacity obtained after the second discharge process.

In some embodiments, the catholyte includes an oxidized form of a compound and the anolyte includes the reduced form of the compound.

In some embodiments, the method further includes further successive discharge processes by continued reversing of the polarity of the catholyte and anolyte compartments with respect to the membrane.

In some embodiments, the catholyte includes a radical dication of a compound of Formula I; and the anolyte includes a neutral radical of a compound of Formula I;
wherein the compound of Formula (I) is represented by the following structure:

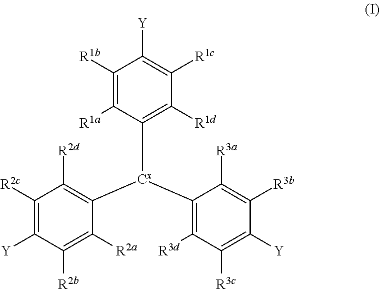

wherein:
   x is from −4 to +4;
   each of R^{1a}, R^{1b}, R^{1c}, R^{1d}, R^{2a}, R^{2b}, R^{2c}, R^{2d}, R^{3a}, R^{3b}, R^{3c}, and R^{3d} is independently H, halide, CF₃, NH₂, C₁-C₁₂ alkyl, C₁-C₄ alkoxy, C₁-C₄ alkylamino, C₁-C₄ dialkyl amino, NO₂, CN, CO₂R, or Ar¹;
   or R^{2a} and R^{3d} together form —X¹—;
   or R^{1a} and R^{2d} together form —X²—;
   or R^{1d} and R^{3a} together form —X³—;
   or R^{1a} and R^{1b} together with atoms to which they are attached to form a phenyl;
   or R^{2c} and R^{2d} together with atoms to which they are attached to form a phenyl;
   each of X¹, X² and X³ is independently O, NR^{4a}, PR^{4a}, CR^{4a}R^{4b}, or SiR^{4a}R^{4b};
   each of R^{4a} and R^{4b} is independently H, halide, CF₃, C₁-C₁₂ alkyl, C₁-C₄ alkoxy, C₁-C₄ alkylamino, C₁-C₄ dialkyl amino, Ar³, -L-Ar³, -L-Z, or -L²-Z²;
   each of Y is independently H, halide, OR^{5a}, NR^{5a}R^{5b}, PR^{5a}R^{5b}, NO₂, CN, CF₃, CO₂R, N₃, or Ar²;
   each of R^{5a}, and R^{1b} is independently H, CF₃, C₁-C₁₂ alkyl, C₁-C₄ alkoxy, C₁-C₄ alkylamino, C₁-C₄ dialkyl amino, Ar⁴, -L¹-Ar⁴, or -L¹-Z¹;
   each of L and L¹ is independently C₁-C₁₂ alkylene, C₁-C₁₂ heteroalkylene, or arylene;
   each of L² is independently C₁-C₁₂ alkylene;
   Z and Z¹ are each independently a moiety comprising conjugated heterocyclic carbenium;
   Z² is each independently —(OCH₂CH₂O)ₙCH₃;
   n is each independently 1 to 20;
   each of R is independently C₁-C₁₂ alkyl or aryl;
   Ar¹, Ar², Ar³, and Ar⁴ are each independently unsubstituted or substituted phenyl or unsubstituted or substituted heteroaryl; each of Ar¹, Ar², Ar³, and Ar⁴ is independently substituted with 0 to 5 substituents; the substituents are each independently selected from the group consisting of halide, CF₃, NH₂, C₁-C₄ alkyl, C₁-C₄ alkoxy, C₁-C₄ alkylamino, C₁-C₄ dialkyl amino, NO₂, CN, or aryl.

In some embodiments, the compound of Formula I is a compound of Formula Ia, Formula Ib, or Formula Ic:

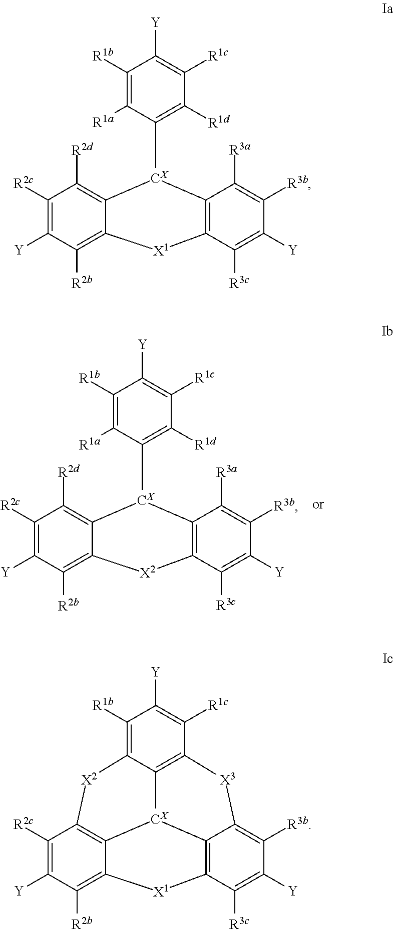

In some embodiments, each of X¹, X², and X³ is independently O or NR^{4a}. In some embodiments, each R^{4a} is independently C₁-C₁₂ alkyl, C₁-C₄ alkoxy, C₁-C₄ alkylamino, C₁-C₄ dialkyl amino, Ar³, -L-Ar³, -L-Z, or -L²-Z². In some embodiments, each R^{4a} is independently methyl, ethyl, propyl, butyl, pentyl, hexyl, —(CH₂)—N(Me)₂, —(CH₂)₂—N(Me)₂, —(CH₂)₃—N(Me)₂, —(CH₂)₃—N(Me)₂, —(CH₂)₄—N(Me)₂, —(CH₂)₂—Ar³, —(CH₂)₃—Ar³, —(CH₂)₃—Ar³, —(CH₂)₄—Ar³—(CH₂)—(OCH₂CH₂O)CH₃, —(CH₂)₂—(OCH₂CH₂O)CH₃, —(CH₂)₃—(OCH₂CH₂O)CH₃, or —(CH₂)₄—(OCH₂CH₂O)CH₃; Ar³ is 2-pyridinyl.

In some embodiments the compound of Formula Ib is a compound, wherein:
X² and X³ are each NR^{4a};
each R^{4a} is independently C₁-C₁₂ alkyl, C₁-C₄ dialkyl amino, -L-Ar³, or -L²-Z²;
R^{1a} and R^{2d} are each C₁-C₄ alkoxy;
each of R^{1b}, R^{1c}, R^{2b}, R^{2c}, R^{3b}, and R^{3c} is independently H, C₁-C₄ alkylamino, or NO₂;
each of Y is independently H, NO₂, or NR^{1a}R^{5b}; and each of R^{5a} and R^{5b} is independently H, CF₃, or C₁-C₁₂ alkyl.

In some embodiments, the compound of Formula I is a compound of any one of the following:

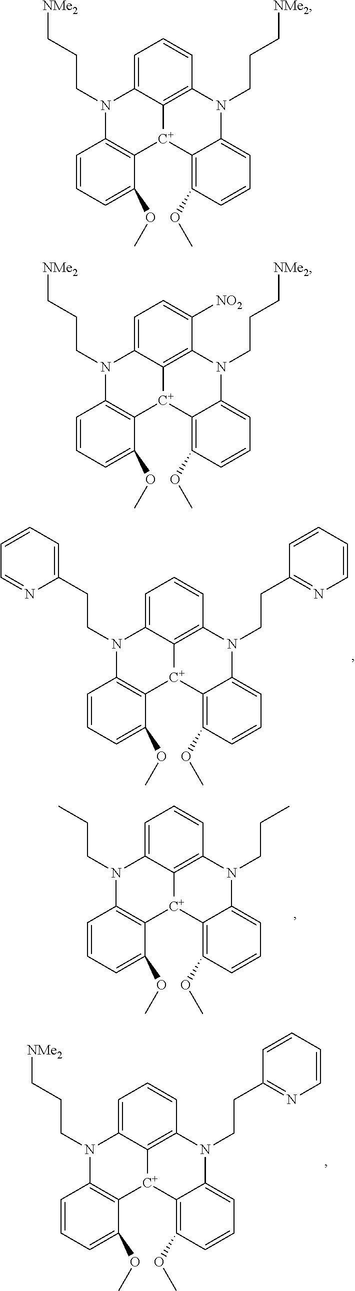

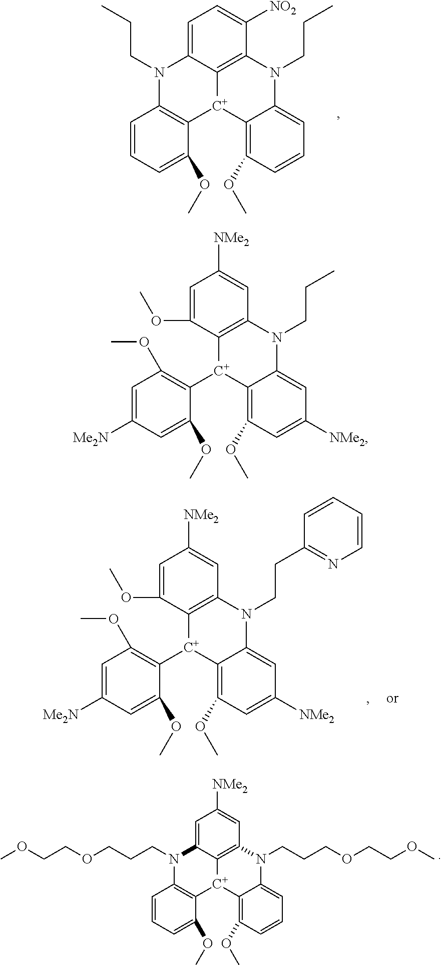

In some embodiments, the compound of formula I further includes an anion selected from tetrafluoroborate, hexafluorophosphate, perchlorate, tetrarylborate, trifluoromethanesulfonate, oxalatoborate, oxalate, phosphate, bis-trifluoromethanesulfonimide, halide, anion of an ionic liquid, hydroxide, carbonate, bicarbonate, sulfate, hydrogen sulfate, sulfite; or a mixture of any two or more thereof.

Also provided in another aspect is a method of charging a symmetrical redox flow battery, the method including:
providing a redox flow battery including:
   a catholyte reservoir containing a catholyte precursor;
   an anolyte reservoir containing an anolyte precursor;
   an ion exchange membrane comprising a first face and an opposing second face; and
applying an oxidizing potential to the catholyte precursor in the catholyte reservoir to generate a catholyte;
applying a reducing potential to the anolyte precursor in the anolyte reservoir to generate an anolyte;
wherein:
   the anolyte precursor is the same as the catholyte precursor; and
   the first face of the ion exchange membrane is in fluid communication with the catholyte; and
   the second face of the ion exchange membrane is in fluid communication with the anolyte.

### BRIEF DESCRIPTION OF THE DRAWINGS

FIG. 1 is an illustration of a redox flow battery—Type 1 RFB, according to some embodiments.

FIG. 2 is an illustration of a redox flow battery—Type 2 RFB, according to some embodiments.

FIG. 3 is an illustration of a small non-aqueous organic redox flow battery.

FIG. 4 is a figure showing the monitoring of the regeneration experiment by reversing the polarity during 110 cycles. 20 cycles at 30 C followed by a cycle in reverse polarity at 5 C, then restoration of the initial polarity at 30 C.

FIG. 5 is a figure showing the focus on the first 50 cycles of regeneration experiment. Polarity reversal after cycles 21 and 43 is characterized by capacity regeneration in cycles 22 and 44 of the RFB system in flow.

FIG. 6 is an illustration showing the regeneration of the symmetric organic redox flow batteries (SORFB) described herein.

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In general, “substituted” refers to an alkyl, alkenyl, alkynyl, aryl, or ether group, as defined below (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like.

As used herein, “alkyl” groups include straight chain and branched alkyl groups having from 1 to about 20 carbon atoms, and typically from 1 to 12 carbons or, in some embodiments, from 1 to 8 carbon atoms. As employed herein, “alkyl groups” include cycloalkyl groups as defined below. Alkyl groups may be substituted or unsubstituted. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, sec-butyl, t-butyl, neopentyl, and isopentyl groups. Representative substituted alkyl groups may be substituted one or more times with, for example, amino, thio, hydroxy, cyano, alkoxy, and/or halo groups such as F, Cl, Br, and I groups. As used herein the term haloalkyl is an alkyl group having one or more halo groups. In some embodiments, haloalkyl refers to a per-haloalkyl group.

The term “alkylene” refers to a saturated linear divalent hydrocarbon moiety or a branched saturated divalent hydrocarbon moiety. Exemplary alkylene groups include, but are not limited to, methylene, ethylene, propylene, butylene, pentylene, 2-methylpropylene, and the like.

The term “heteroalkylene” refers to an alkylene group as defined herein in which one or more chain atoms or hydrogen atoms are replaced with a heteroatom such as O, N, P, or S. Exemplary heteroalkylenes include, but are not limited to, polyethylene glycol derived heteroalkylenes such as PEG2 (i.e, 2 molecules of ethylene glycols are linked), PEG3, 2-methoxyethylene, 2-hydroxyethyl, 2,3-dihydroxypropyl, etc.

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 6, or 7. Cycloalkyl groups may be substituted or unsubstituted. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined above. Representative substituted cycloalkyl groups may be mono-substituted or substituted more than once, such as, but not limited to: 2,2-; 2,3-; 2,4-; 2,5-; or 2,6-disubstituted cyclohexyl groups or mono-, di-, or tri-substituted norbornyl or cycloheptyl groups, which may be substituted with, for example, alkyl, alkoxy, amino, thio, hydroxy, cyano, and/or halo groups.

Alkenyl groups are straight chain, branched or cyclic alkyl groups having 2 to about 20 carbon atoms, and further including at least one double bond. In some embodiments alkenyl groups have from 1 to 12 carbons, or, typically, from 1 to 8 carbon atoms. Alkenyl groups may be substituted or unsubstituted. Alkenyl groups include, for instance, vinyl, propenyl, 2-butenyl, 3-butenyl, isobutenyl, cyclohexenyl, cyclopentenyl, cyclohexadienyl, butadienyl, pentadienyl, and hexadienyl groups among others. Alkenyl groups may be substituted similarly to alkyl groups. Divalent alkenyl groups, i.e., alkenyl groups with two points of attachment, include, but are not limited to, CH—CH═CH₂, C═CH₂, or C═CHCH₃.

As used herein, “aryl” or “aromatic,” groups are cyclic aromatic hydrocarbons that do not contain heteroatoms. Aryl groups include monocyclic, bicyclic and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. The phrase “aryl groups” includes groups containing fused rings, such as fused aromatic-aliphatic ring systems (e.g., indanyl, tetrahydronaphthyl, and the like). Aryl groups may be substituted or unsubstituted.

As used herein, “arylene” refers to a bivalent group derived from an arene where a hydrogen atom has been removed from two ring carbon atoms.

Heteroalkyl group include straight and branched chain alkyl groups as defined above and further include 1, 2, 3, 4, 5, or 6 heteroatoms independently selected from oxygen, sulfur, and nitrogen. Thus, heteroalkyl groups include 1 to 12 carbon atoms, 1 to 10 carbons or, in some embodiments, from 1 to 8, or 1, 2, 3, 4, 5, or 6 carbon atoms, or any range therein (e.g., 1-4). Examples of heteroalkyl groups include, but are not limited to, —(CH₂CH₂O)₁₋₅CH₃, —(CH₂)₁₋₆O(CH₂)₁₋₆ CH₃, —(CH₂)₁₋₆NRₐ(CH₂)₁₋₆ CH₃, —(CH₂)₁₋₆S(CH₂)₁₋₆ CH₃, —(CH₂)₁₋₆O(CH₂)₁₋₆O(CH₂)₁₋₆ CH₃, —(CH₂)₁₋₆ NRₐ(CH₂)₁₋₆ NRₐ(CH₂)₁₋₆CH₃, —(CH₂)₁₋₆O(CH₂)₁₋₆O(CH₂)₁₋₆O(CH₂)₁₋₆CH₃, —(CH₂)₁₋₆NRₐ(CH₂)₁₋₆NRₐ(CH₂)₁₋₆NRₐ(CH₂)₁₋₆CH₃, with the total number of carbon atoms in the heteroalkyl group being 1 to 12 and R^{a} is a hydrogen or a substituted or unsubstituted alkyl, alkenyl, aryl or aralkyl group. Other examples of heteroalkyl groups include, but are not limited to, groups having different heteroatoms in a single group. Such examples of heteroalkyl groups include, but are not limited to, —(CH₂)₁₋₆S(CH₂)₁₋₆O(CH₂)₁₋₆, —(CH₂)₁₋₆ NRₐ(CH₂)₁₋₆)O(CH₂)₁₋₆, —(CH₂)₁₋₆O(CH₂)₁₋₆ NRₐ(CH₂)₁₋₆S(CH₂)₁₋₆, —(CH₂)₁₋₆NRₐ(CH₂)₁₋₆O(CH₂)₁₋₆S(CH₂)₁₋₆, with the total number of carbon atoms in the heteroalkyl group being 1 to 12. In some embodiments, heteroalkyl groups include, but are not limited to, polyoxyethylene groups, such as —(OCH₂CH₂—)₁₋₅CH₃, for example, —O(CH₂)₂O(CH₂)₂OCH₃, —O(CH₂)₂O(CH₂)₂O(CH₂)₂OCH₃, —O(CH₂)₂O(CH₂)₂O(CH₂)₂O(CH₂)₂OCH₃.

Aralkyl groups are substituted aryl groups in which an alkyl group as defined above has a hydrogen or carbon bond of the alkyl group replaced with a bond to an aryl group as defined above. In some embodiments, aralkyl groups contain 7 to 14 carbon atoms, 7 to 10 carbon atoms, e.g., 7, 8, 9, or 10 carbon atoms or any range therein (e.g., 7-8). Aralkyl groups may be substituted or unsubstituted. Substituted aralkyl groups may be substituted at the alkyl, the aryl or both the alkyl and aryl portions of the group. Representative substituted and unsubstituted alkaryl groups include but are not limited to alkylphenyl such as methylphenyl, (chloromethyl)phenyl, chloro(chloromethyl)phenyl, or fused alkaryl groups such as 5-ethylnaphthalenyl.

Heterocyclyl groups are non-aromatic ring compounds containing 3 or more ring members, of which one or more is a heteroatom such as, but not limited to, N, O, and S. In some embodiments, the heterocyclyl group contains 1, 2, 3 or 4 heteroatoms. In some embodiments, heterocyclyl groups include mono-, bi- and tricyclic rings having 3 to 16 ring members, whereas other such groups have 3 to 6, 3 to 10, 3 to 12, or 3 to 14 ring members. Heterocyclyl groups encompass partially unsaturated and saturated ring systems, such as, for example, imidazolinyl and imidazolidinyl groups. The phrase also includes bridged polycyclic ring systems containing a heteroatom such as, but not limited to, quinuclidyl. The phrase also includes heterocyclyl groups that have other groups, such as alkyl, oxo or halo groups, bonded to one of the ring members, referred to as “substituted heterocyclyl groups”. Heterocyclyl groups include, but are not limited to, aziridinyl, azetidinyl, pyrrolidinyl, imidazolidinyl, pyrazolidinyl, thiazolidinyl, tetrahydrothiophenyl, tetrahydrofuranyl, dioxolyl, pyrrolinyl, piperidyl, piperazinyl, morpholinyl, thiomorpholinyl, tetrahydropyranyl, and tetrahydrothiopyranyl groups. Representative substituted heterocyclyl groups may be mono-substituted or substituted more than once, such as, but not limited to, morpholinyl groups, which are 2-, 3-, 4-, 5-, or 6-substituted, or disubstituted with various substituents such as those listed above. The heteroatom(s) may also be in oxidized form, if chemically possible.

Heteroaryl groups are aromatic ring compounds containing 5 or more ring members, of which, one or more is a heteroatom such as, but not limited to, N, O, and S. Heteroaryl groups include, but are not limited to, groups such as pyrrolyl, pyrazolyl, triazolyl, tetrazolyl, oxazolyl, isoxazolyl, thiazolyl, pyridinyl, pyridazinyl, pyrimidinyl, pyrazinyl, thiophenyl, benzothiophenyl, furanyl, imidazolyl, benzofuranyl, indolyl, azaindolyl (pyrrolopyridinyl), indazolyl, benzimidazolyl, imidazopyridinyl (azabenzimidazolyl), pyrazolopyridinyl, triazolopyridinyl, benzotriazolyl, benzoxazolyl, benzothiazolyl, benzothiadiazolyl, imidazopyridinyl, isoxazolopyridinyl, thianaphthyl, purinyl, xanthinyl, adeninyl, guaninyl, quinolinyl, isoquinolinyl, tetrahydroquinolinyl, quinoxalinyl, and quinazolinyl groups. Heteroaryl groups include fused ring compounds in which all rings are aromatic such as indolyl groups and include fused ring compounds in which only one of the rings is aromatic, such as 2,3-dihydro indolyl groups. The phrase “heteroaryl groups” includes fused ring compounds and also includes heteroaryl groups that have other groups bonded to one of the ring members, such as alkyl groups, referred to as “substituted heteroaryl groups.” Representative substituted heteroaryl groups may be substituted one or more times with various substituents such as those listed above. The heteroatom(s) may also be in oxidized form, if chemically possible.

The term “halogen” or “halo” as used herein refers to bromine, chlorine, fluorine, or iodine. In some embodiments, the halogen is fluorine. In other embodiments, the halogen is chlorine or bromine. The term “halide” as used herein refers to the anion of a halogen, such as bromide, chloride, fluoride, and iodide. In some embodiments, the halide is chloride or iodide.

The terms “alkoxy” refers to a substituted or unsubstituted alkyl group bonded to an oxygen atom, such as a moiety of the formula —OR^{a}, wherein R^{a} is alkyl as defined herein. Examples include but are not limited to methoxy and ethoxy. Representative substituted alkoxy groups may be substituted one or more times with substituents such as those listed above, such as methoxymethyl and fluoromethoxy.

The term “alkylamino” refers to a moiety of the formula —NHR^{a}, where R^{a} is alkyl as defined herein.

The term “dialkyl amino” refers to a moiety of the formula —NR^{a}R^{b}, wherein R^{a} and R^{b} are independently alkyl as defined herein.

Disclosed herein are methods for regenerating or charging redox flow battery systems comprising conjugated heterocyclic carbenium compounds as both the anolyte and catholyte (e.g., symmetrical redox flow battery systems). These conjugated heterocyclic carbenium compounds are redox active compounds that can reversibly be reduced and oxidized and are photoactive. Using the same compound as both catholyte and analyte avoids cross over contamination and reduced battery life associated with current redox flow battery systems.

Redox flow battery systems comprising the conjugated heterocyclic carbenium compounds described herein have been shown on the laboratory scale to efficiently deliver 2.1V of open circuit voltage for more than 500 cycles (if extrapolated to one cycle a day, this correspond to more than 1.5 years battery life at more than 90% coulombic efficiency with 90% of charge—discharge capacity used). This disclosure is directed to the development of a regeneration process with these symmetrical redox flow battery systems comprising the conjugated heterocyclic carbenium compounds, wherein the efficiency of the electrolyte is regained by simply cycling the batter under reverse polarization. As shown in the Examples, preliminary results show that up to 5 regeneration sequences may be performed with these symmetrical redox flow battery systems and allow for a recuperation of up to 35% of charge capacity after the first cycle due to 2 cycles of reverse polarization.

This regeneration process has been theoretically discussed in the literature and highlights that it is potentially possible to recover capacity loss due to the degradation of the energy carrier compound by regular polarity reversals. Thus, the lifetime of the cell as well as the redox-active material is greatly increased, and can theoretically be multiplied by the number of polarity reversal sequences accessible by the system before too much damage occurs. The robustness of the battery would be greatly increased, and its levelized cost of storage (LCOS) would be drastically reduced.

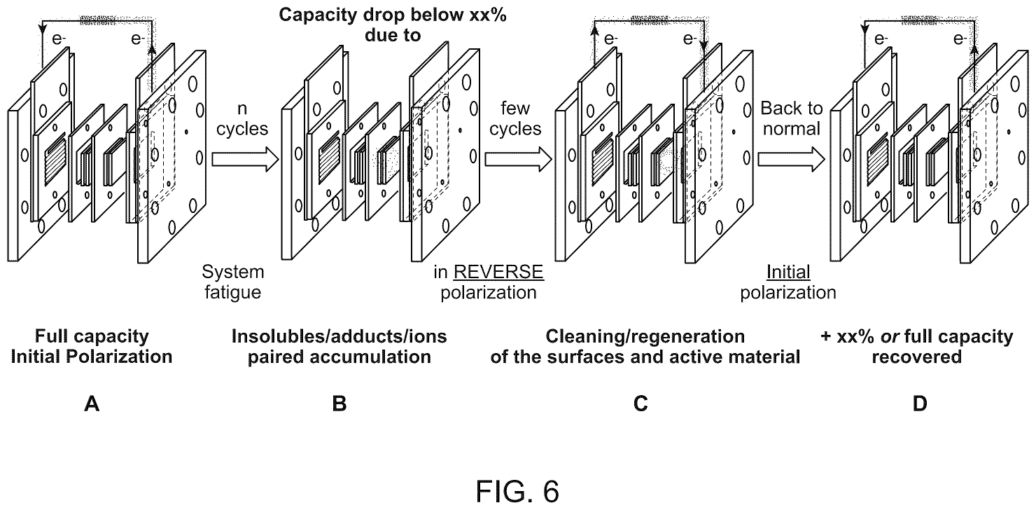

FIG. 6 illustrates the regeneration process of the symmetrical redox flow battery systems discussed herein. Initially, the battery is polarized in one direction to store energy (A). Due to the variations of conditions (current, potential, temperature, solvent evaporation, local overload, nature of the electrolyte), the system will undergo fatigue, leading to the accumulation of insoluble, parasitic reaction, or undesirable functionalization of carbon electrodes (B). In a classical asymmetric RFB, there is no choice but to replace the electrodes, the membrane, and the damaged active redox material, which leads to phenomenal costs. The symmetrical mono-molecular design of our RFB allows, without dismantling any part of the system, to regenerate and clean the elements affected by (non-irreversible) degradations by simple polarity inversion (C). Thus, the formation of the redox state antagonistic to the one observed in the initial polarization at the degraded electrode (C) comes to react and “reset” the properties of our battery. After a few cycles of reverse polarization, the polarization can be restored to its initial direction, and the system is considered as “regenerated” (D).

This regeneration is also almost transparent for the user, because during the regeneration sequences, the battery continues to store energy as it would in its initial polarization. This not only prolongs the life of the RFB, but also makes it easier to use and more robust than ever.

Provided in one aspect is a method of regenerating a symmetrical redox flow battery, the method including:
a first discharge process having a duration in which a capacity of the redox flow battery in a first polarity and including a membrane decreases from a first capacity to a second capacity, the process including:
   flowing a catholyte through a catholyte compartment of the redox flow battery in the first polarity;
   flowing an anolyte through an anolyte compartment of the redox flow battery in the first polarity;
   wherein:
      the first polarity of the redox flow battery includes the membrane having a first face in fluid communication with the catholyte compartment and a second face in fluid communication with the anolyte compartment; and
      the first and the second faces of the membrane being opposing surfaces of the membrane; and
a second discharge process including:
   reversing the polarity of the catholyte and anolyte compartments to a second polarity with respect to the membrane, such that the catholyte compartment is in fluid communication with the second face of the membrane, and the anolyte compartment is in fluid communication with the first face of the membrane; and
   flowing the catholyte through the catholyte compartment of the redox flow battery in the second polarity; and
   flowing the anolyte through the anolyte compartment of the redox flow battery in the second polarity;
   wherein:
      the redox flow battery in the second polarity exhibits an initial increased capacity compared to the second capacity from the first discharge process.

In some embodiments, after determining a reduction in capacity during the second discharge process, reversing the second polarity to a third polarity, which is the same as the first polarity with respect to the catholyte and anolyte compartment, and subjecting the redox flow battery to a third discharge process where the initial capacity of the third discharge process is greater than the reduced capacity obtained after the second discharge process.

In some embodiments, the catholyte includes an oxidized form of a compound and the anolyte includes the reduced form of the compound.

In some embodiments, the method further includes further successive discharge processes by continued reversing of the polarity of the catholyte and anolyte compartments with respect to the membrane.

Also provided in another aspect is a method of charging a symmetrical redox flow battery, the method including:
providing a redox flow battery including:
   a catholyte reservoir containing a catholyte precursor;
   an anolyte reservoir containing an anolyte precursor;
   an ion exchange membrane comprising a first face and an opposing second face; and
applying an oxidizing potential to the catholyte precursor in the catholyte reservoir to generate a catholyte;
applying a reducing potential to the anolyte precursor in the anolyte reservoir to generate an anolyte;
wherein:
   the anolyte precursor is the same as the catholyte precursor; and
   the first face of the ion exchange membrane is in fluid communication with the catholyte; and
      the second face of the ion exchange membrane is in fluid communication with the anolyte.

These conjugated heterocyclic carbenium ions are easily prepared from successive double S_{N}Ar reactions between tris(2,6-dimethoxyphenyl)carbenium ion and primary amines at moderate-to-high temperatures with methanol elimination. These stable carbenium salts are of particular interest because: 1) they are among the most stable carbocation in the literature, including under mild acidic or basic aqueous conditions; 2) the stepwise and temperature dependence of the synthesis allows versatility by using aliphatic or aromatic amines, and forming unsymmetrical ions; 3) they can be functionalized via C—H borylation, and/or metal-catalyzed cross-coupling; and 4) the negative counterions can be exchanged to affect the physical and chemical properties of the salts. Not only are these conjugated heterocyclic carbenium compounds also highly fluorescent with large extinction coefficients and long fluorescence life times, these conjugated heterocyclic carbenium compounds are redox active species with three stable redox states: carbodication, carbocation, and neutral carboradical.

The redox states of the heterocyclic carbenium compounds are illustrated in the below Scheme. Neutral radical (C^{•}) and radical dication (C^{++•}) can lose and gain an electron respectively to form the carbocation (C⁺), resulting in the battery discharge and generation of electricity (Scheme 1; steps with red dashed arrows). Alternately, the carbocation (C⁺) can gain or lose an electron to convert to the neutral radical (C^{•}) or radical dication (C^{++•}) respectively, resulting in battery charge (Scheme A; steps with blue solid arrows).

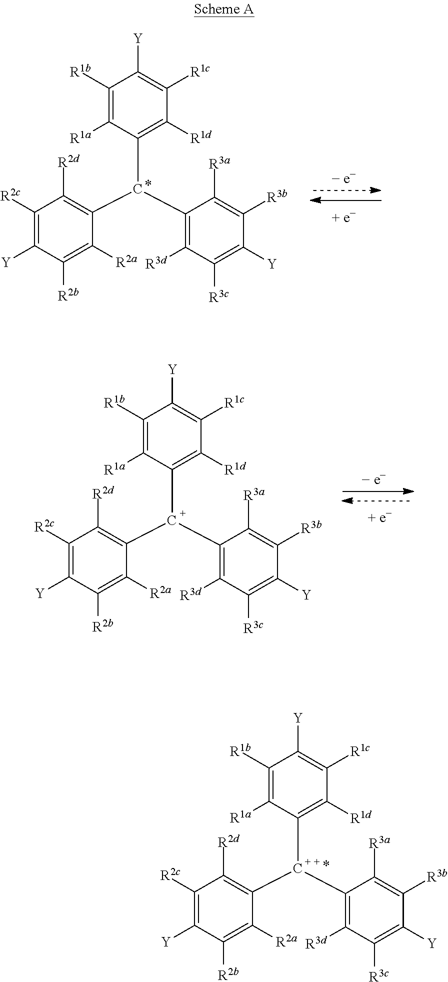

Their stability, reduction and oxidation potential, solubility in organic solvent, and tunability via simple organic transformation make these compounds ideal candidates to be tested as the anolyte and catholyte for RFBs.

Additionally, the heterocyclic carbenium compounds are photoactive, thus allowing for the development of a system where the battery is photo catalytically charged. The carbocation can be excited by visible light (>500 nm). It's excited state (C⁺*) can get oxidized to C^{++•} or reduced to C• at an electrode.

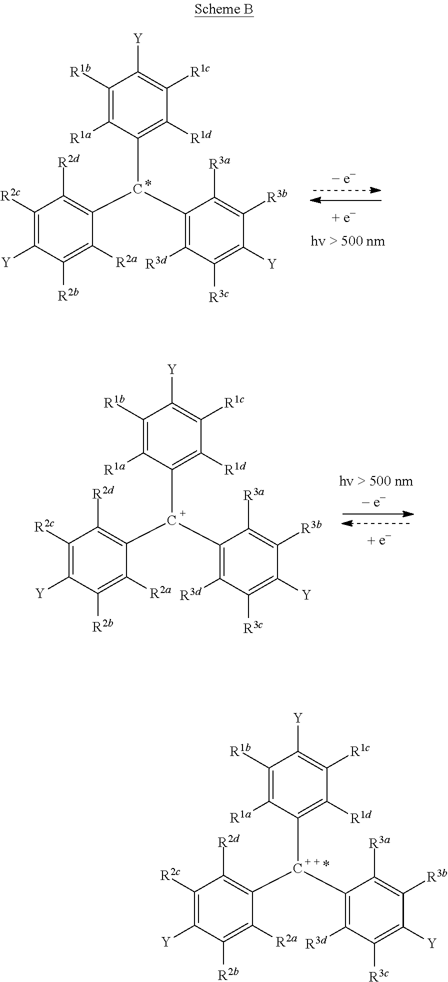

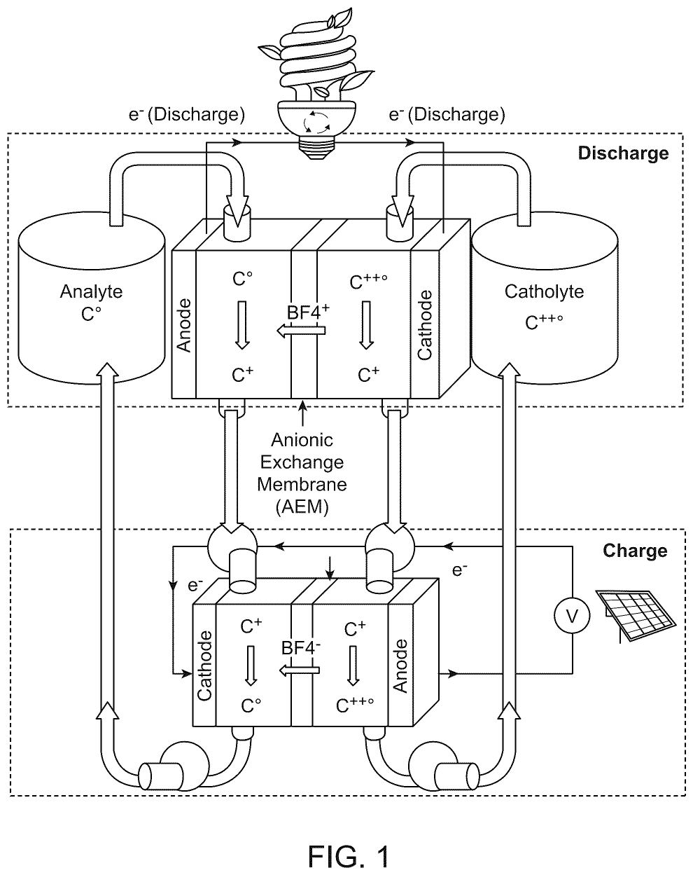

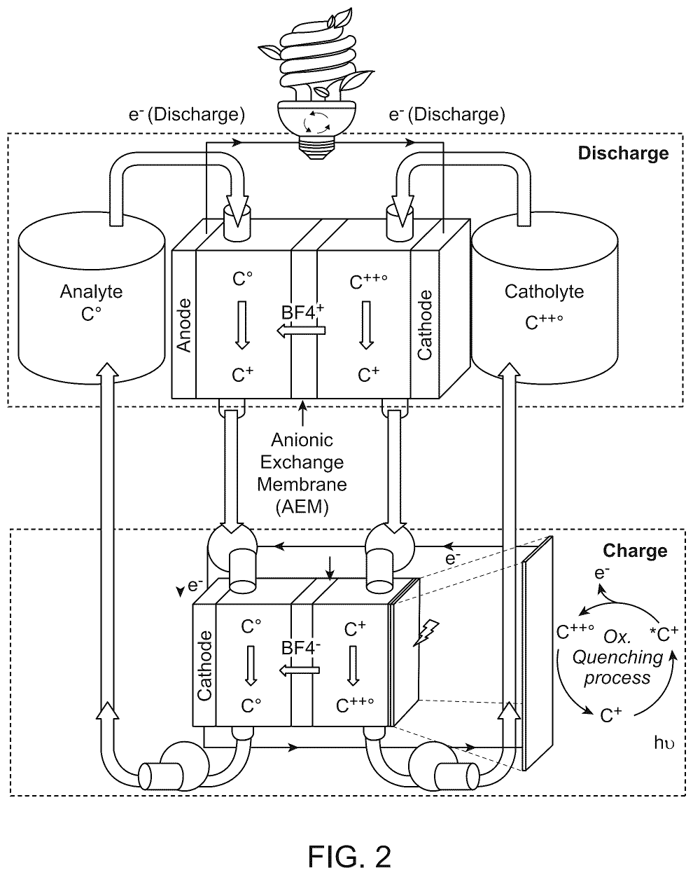

Due to both the electrochemical and photochemical properties of heterocyclic carbenium compounds, redox flow battery systems may be developed using these compounds as both the anolyte and catholyte. The redox flow batteries described herein may include a catholyte compartment that contains the catholyte, an anolyte compartment that contains the anolyte, and a porous separator (e.g., a membrane or other cation-permeable material) partitioning the catholyte and anolyte compartments. Two illustrative examples are shown in FIGS. 1 and 2. In both cases the generation of current from the battery come from the discharge of C• and C^{++•} forming C⁺ upon losing and gaining an electron respectively.

FIG. 1 shows an embodiment of the redox flow battery—Type I RFB. For this embodiment, the charge occurs via an electric current provided by an external source of energy, such an ideal renewable energy that need to be stored (e.g., wind, solar, and the like). In the preliminary experiments disclosed herein, the current is provided by a potentiostat.

FIG. 2 shows an embodiment of the redox flow battery—Type II RFB. The Type II RFB uses the photovoltaic properties of C⁺, in which after absorption of visible light, the excited state can be oxidized back to the catholyte C^{++•} upon loss of an electron. That electron can travel to the cathode to reduce C⁺ to the anolyte C^{•}.

Furthermore, the use of the conjugated heterocyclic carbenium compounds as both the anolyte and catholyte also allows for the development of a symmetric organic redox flow battery (SORFB). This provides an opportunity to improve the properties of the exchange membrane (EM) that separates the two poles of the battery and overcome the limitations associated with vanadium-based RFBs as mentioned above. In particular, the anion-selective membrane typically used in vanadium-based RFBs is replaced with a simple porous exchanged membrane (EM), where the pore size of the EM provides selectivity based on size exclusion. Compared to VRFBs and other RFBs, the threat of leakage of electroactive materials from one pole of the battery to the other is minimized for a SORFBs, since the use of conjugated heterocyclic carbenium compounds as both the anolyte and catholyte reduces the chemical gradient of electroactive species and decreases crossover. Even if transmembrane crossover occurs, SRFBs may undergo self-discharge, thus restoring the ROM to its initial redox state instead of permanent contamination and electrolyte degradation. As such, the symmetric RFBs can potentially be stored indefinitely without irreversible side reactions. Exemplary porous exchanged membranes (EM), where the pore size of the EM provides selectivity based on size exclusion, are further discussed herein.

The redox flow batteries described herein include: a catholyte including a radical dication of a conjugated heterocyclic carbenium compound; and an anolyte including a neutral radical of a conjugated heterocyclic carbenium compound; wherein the conjugated heterocyclic compounds present in the catholyte and anolyte are the same compound. “Same compound” as used herein refers to two different species, such as the radical dication and neutral radical, while having different oxidation states/charges, have the same atomic components and structure of the cathodic and anodic species.

In some embodiments, the catholyte include a radical dication of a compound of Formula I; and the anolyte includes a neutral radical of a compound of Formula I; wherein the compound of Formula (I) is represented by the following structure disclosed herein.

The conjugated heterocyclic carbenium compounds disclosed herein are compounds of Formula I. The compound of Formula (I) is represented by the following structure:

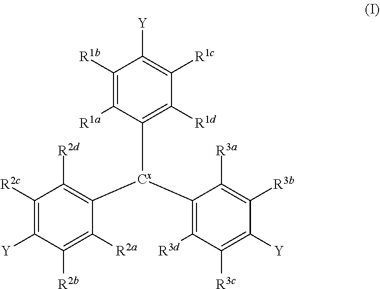

wherein:
   X is from −4 to +4;
   each of R^{1a}, R^{1b}, R^{1c}, R^{1d}, R^{2a}, R^{2b}, R^{2c}, R^{2d}, R^{3a}, R^{3b}, R^{3c}, and R^{3d} is independently H, halide, CF₃, NH₂, C₁-C₁₂ alkyl, C₁-C₄ alkoxy, C₁-C₄ alkylamino, C₁-C₄ dialkyl amino, NO₂, CN, CO₂R, or Ar¹;
   or R^{2a} and R^{3d} together form —X¹—;
   or R^{1a} and R^{2d} together form —X²—;
   or R^{1d} and R^{3a} together form —X³—;
   or R^{1a} and R^{1b} together with atoms to which they are attached to form a phenyl;
   or R^{2c} and R^{2d} together with atoms to which they are attached to form a phenyl;
   each of X¹, X² and X³ is independently O, NR^{4a}, PR^{4a}, CR^{4a}R^{4b}, or SiR^{4a}R^{4b};
   each of R^{4a} and R^{4b} is independently H, halide, CF₃, C₁-C₁₂ alkyl, C₁-C₄ alkoxy, C₁-C₄ alkylamino, C₁-C₄ dialkyl amino, Ar³, -L-Ar³, -L-Z, or -L²-Z²
   each of Y is independently H, halide, OR^{5a}, NR^{5a}R^{5b}, PR^{5a}R^{5b}, NO₂, CN, CF₃, CO₂R, N₃, or Ar²;
   each of R^{5a}, and R^{5b} is independently H, CF₃, C₁-C₁₂ alkyl, C₁-C₄ alkoxy, C₁-C₄ alkylamino, C₁-C₄ dialkyl amino, Ar⁴, -L¹-Ar⁴, or -L¹-Z¹;
   each of L and L¹ is independently C₁-C₁₂ alkylene, C₁-C₁₂ heteroalkylene, or arylene;
   each of L² is independently C₁-C₁₂ alkylene;
   Z and Z¹ are each independently a moiety comprising conjugated heterocyclic carbenium;
   Z² is each independently —(OCH₂CH₂O)ₙCH₃;
   n is each independently 1 to 20;
   each of R is independently C₁-C₁₂ alkyl or aryl;
   Ar¹, Ar², Ar³, and Ar⁴ are each independently unsubstituted or substituted phenyl or unsubstituted or substituted heteroaryl; each of Ar¹, Ar², Ar³, and Ar⁴ is independently substituted with 0 to 5 substituents; the substituents are each independently selected from the group consisting of halide, CF₃, NH₂, C₁-C₄ alkyl, C₁-C₄ alkoxy, C₁-C₄ alkylamino, C₁-C₄ dialkyl amino, NO₂, CN, or aryl.

In some embodiments, the compound of Formula I is a compound of Formula Ia, Formula Ib, or Formula Ic:

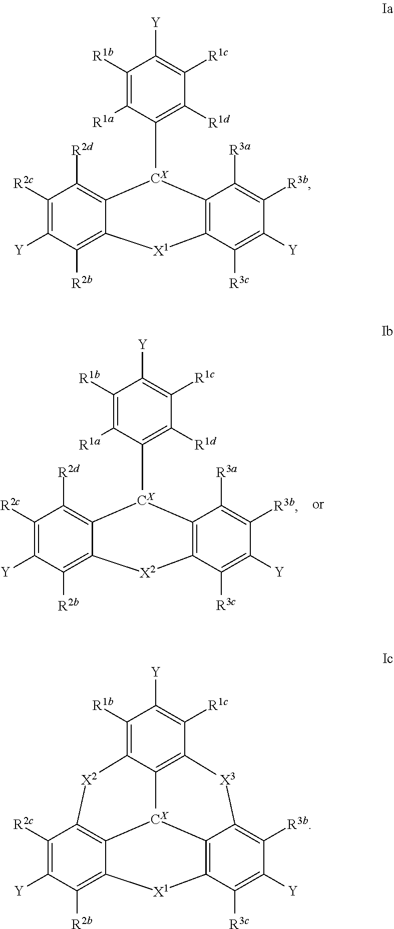

In some embodiments, X is −4, -3, -2, −1, 0, 1, 2, 3, or 4. In some embodiments, each of X¹, X², and X³ is independently O or NR^{4a}. In some embodiments, X¹ is 0 or NR^{4a}In some embodiments, X² is 0 or NR^{4a}. In some embodiments, X³ is 0 or NR^{4a}.

In some embodiments, each R^{4a} is independently C₁-C₁₂ alkyl, C₁-C₄ alkoxy, C₁-C₄ alkylamino, C₁-C₄ dialkyl amino, Ar³, -L-Ar³, -L-Z, or -L²-Z². In some embodiments, each R^{4a} is independently C₁-C₁₂ alkyl, C₁-C₄ alkoxy, C₁-C₄ alkylamino, C₁-C₄ dialkyl amino, Ar³, -L-Ar³, or -L-Z. In some embodiments, R^{4a} is C₁-C₁₂ alkyl. In some embodiments, R^{4a} is C₁-C₄ alkoxy. In some embodiments, R^{4a} is C₁-C₄ alkylamino. In some embodiments, R^{4a} is C₁-C₄ dialkyl amino. In some embodiments, R^{4a} is Ar³. In some embodiments, R^{4a} is -L-Ar³. In some embodiments, R^{4a} is -L-Z. In some embodiments, R^{4a} is -L²-Z².

In some embodiments, each R^{4a} is independently methyl, ethyl, propyl, butyl, pentyl, hexyl, —(CH₂)—N(Me)₂, —(CH₂)₂—N(Me)₂, —(CH₂)₃—N(Me)₂, —(CH₂)₃—N(Me)₂, —(CH₂)₄—N(Me)₂, —(CH₂)₂—Ar³, —(CH₂)₃—Ar³, —(CH₂)₃—Ar³, or —(CH₂)₄—Ar³; and Ar³ is 2-pyridinyl. In some embodiments, R^{4a} is methyl, ethyl, propyl, butyl, pentyl, or hexyl. In some embodiments, R^{4a} is —(CH₂)—N(Me)₂, —(CH₂)₂—N(Me)₂, —(CH₂)₃—N(Me)₂, —(CH₂)₃—N(Me)₂, or —(CH₂)₄—N(Me)₂. In some embodiments, R^{4a} is —(CH₂)₂—Ar³, —(CH₂)₃—Ar³, —(CH₂)₃—Ar³, or —(CH₂)₄—Ar³. In some embodiments, Ar³ is pyridinyl, such as 2-pyridinyl. In some embodiments, R^{4a} is —(CH₂)—(OCH₂CH₂O)ₙCH₃; wherein n is 0, 1, 2, 3, 4, 5, 6, 7, 8, 9, 10, 11, 12, 13, 14, 15, 16, 17, 18, 19, or 20. In some embodiments, R^{4a} is —(CH₂)₂—(OCH₂CH₂O)ₙCH₃; wherein n is 0, 1, 2, 3, 4, 5, 6, 7, 8, 9, 10, 11, 12, 13, 14, 15, 16, 17, 18, 19, or 20. In some embodiments, R^{4a} is —(CH₂)₃—(OCH₂CH₂O)ₙCH₃; wherein n is 0, 1, 2, 3, 4, 5, 6, 7, 8, 9, 10, 11, 12, 13, 14, 15, 16, 17, 18, 19, or 20. In some embodiments, R^{4a} is —(CH₂)₄—(OCH₂CH₂O)ₙCH₃; wherein n is 0, 1, 2, 3, 4, 5, 6, 7, 8, 9, 10, 11, 12, 13, 14, 15, 16, 17, 18, 19, or 20. In some embodiments, R^{4a} is —(CH₂)₃—(OCH₂CH₂O)ₙCH₃; wherein n is 1.

In some embodiments, Y is an electron-withdrawing substituent. In some instances, the additional of an electron withdrawing, such as NO₂, improves the stability to oxygen and also adds a reduction potential, allowing the storage of more than one electron per molecule. In some embodiments, the compound of Formula I has one, two, or three Y groups, where Y is NO₂. In some embodiments, Y is an electron donating substituent. In some embodiments, each of Y is independently H or NO₂. In some embodiments, each of Y is H. In some embodiments, Y is NO₂. In some embodiments, Y is NR^{5a}R⁵¹ with each of R^{5a}, and R^{5b} is independently C₁-C₁₂ alkyl. In some embodiments, Y is N(Me)₂.

In some embodiments, R^{1a} and R^{2d} are each C₁-C₄ alkoxy. In some embodiments, R^{1a} is C₁-C₄ alkoxy, such as methoxy or ethoxy. In some embodiments, R^{2d} is C₁-C₄ alkoxy, such as methoxy or ethoxy.

In some embodiments, R^{1d} and R^{3a} are each C₁-C₄ alkoxy. In some embodiments, R^{1d} is C₁-C₄ alkoxy, such as methoxy or ethoxy. In some embodiments, R^{3a} is C₁-C₄ alkoxy, such as methoxy or ethoxy.

In some embodiments, each of R^{1a}, R^{1b}, R^{1c}, R^{1d}, R^{2a}, R^{2b}, R^{2c}, R^{2d}, R^{3a}, R^{3b}, R^{3c}, and R^{3d} is independently H. In some embodiments, each of R^{1b}, R^{1c}, R^{2b}, R^{2c}, R^{3b}, and R^{3c} is independently H. In some embodiments, R^{1b} is H. In some embodiments, R^{1c} is H. In some embodiments, R^{2b} is H. In some embodiments, R^{2c} is H. In some embodiments, R^{3b} is H.

In some embodiments, the compound of Formula Ia is a compound, wherein: X¹ is each NR^{4a}; each R^{4a} is independently C₁-C₁₂ alkyl, C₁-C₄ dialkyl amino, -L-Ar³, or -L²-Z²; R^{1a} R^{1d}, R^{3a}, and R^{2d} are each C₁-C₄ alkoxy; each of R^{1b}, R^{1c}, R^{2b}, R^{2c}, R^{3b}, and R^{3c} is independently H, C₁-C₄ alkylamino, or NO₂; each of Y is independently H, NO₂, or NR^{5a}R^{5b}; and each of R^{5a} and R^{5b} is independently H, CF₃, or C₁-C₁₂ alkyl.

In some embodiments, X¹ is each NR^{4a}. In some embodiments, each R^{4a} is C₁-C₁₂ alkyl. In some embodiments, each R^{4a} is C₁-C₄ dialkyl amino. In some embodiments, each R^{4a} is -L-Ar³. In some embodiments, each R^{4a} is -L²-Z². In some embodiments, R^{1a} R^{1d}, R^{3a}, and R^{2d} are each C₁-C₄ alkoxy. In some embodiments, each of R^{1b}, R^{1c}, R^{2b}, R^{2c}, R^{3b}, and R^{3c} is independently H or C₁-C₄ alkylamino. In some embodiments, each of R^{1b}, R^{1c}, R^{2b}, R^{2c}, R^{3b}, and R^{3c} is independently H or NO₂. In some embodiments, each of Y is independently H or NO₂. In some embodiments, each of Y is independently H, or NR^{5a}R^{5b}. In some embodiments, each of R^{5a} and R^{5b} is independently H or C₁-C₁₂ alkyl.

In some embodiments, the compound of Formula Tb is a compound, wherein:
X² and X³ are each NR^{4a};
each R^{4a} is independently C₁-C₁₂ alkyl, C₁-C₄ dialkyl amino, -L-Ar³, or -L²-Z²;
R^{1a} and R^{2d} are each C₁-C₄ alkoxy;
each of R^{1b}, R^{1c}, R^{2b}, R^{2c}, R^{3b}, and R^{3c} is independently H, C₁-C₄ alkylamino, or NO₂;
each of Y is independently H, NO₂, or NR^{5a}R^{5b}; and
each of R^{5a} and R^{5b} is independently H, CF₃, or C₁-C₁₂ alkyl.

In some embodiments, X² and X³ are each NR^{4a}. In some embodiments, each R^{4a} is C₁-C₁₂ alkyl. In some embodiments, each R^{4a} is C₁-C₄ dialkyl amino. In some embodiments, each R^{4a} is -L-Ar³. In some embodiments, each R^{4a} is -L²-Z². In some embodiments, R^{1a} and R^{2d} are each C₁-C₄ alkoxy. In some embodiments, each of R^{1b}, R^{1c}, R^{2b}, R^{2c}, R^{3b}, and R^{3C} is independently H or C₁-C₄ alkylamino. In some embodiments, each of R^{1b}, R^{1c}, R^{2b}, R^{2c}, R^{3b}, and R^{3c} is independently H or NO₂. In some embodiments, each of Y is independently H or NO₂. In some embodiments, each of Y is independently H, or NR^{5a}R^{5b}. In some embodiments, each of R^{5a} and R^{1b} is independently H or C₁-C₁₂ alkyl.

In some embodiments, the compound of Formula Tb is a compound, wherein:
X² and X³ are each NR^{4a};
each R^{4a} is independently C₁-C₁₂ alkyl, C₁-C₄ dialkyl amino, or L-Ar³;
R^{1a} and R^{2d} are each C₁-C₄ alkoxy;
each of R^{1b}, R^{1c}, R^{2b}, R^{2c}, R^{3b}, and R^{3C} is independently H; and
each of Y is independently H or NO₂.

In any of the embodiment described herein, the compound of Formula I may include functional groups that improves the solubility of the compound or the compound in its redox states in an organic solvent, such as CH₃CN. These functional groups include oligomeric functionality that can increase solubility, such as PEGyl chains (—(OCH₂CH₂O)ₙCH₃) as shown in the below compound. This type of molecular engineering has already been proven in recent literature to drastically increase solubility, and the relevance of this approach was confirmed by a recent community review.

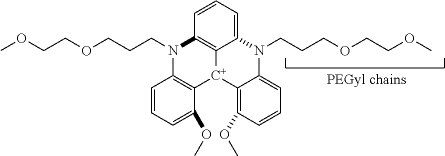

In some embodiments, the compound of Formula I is a compound of any one of the following:

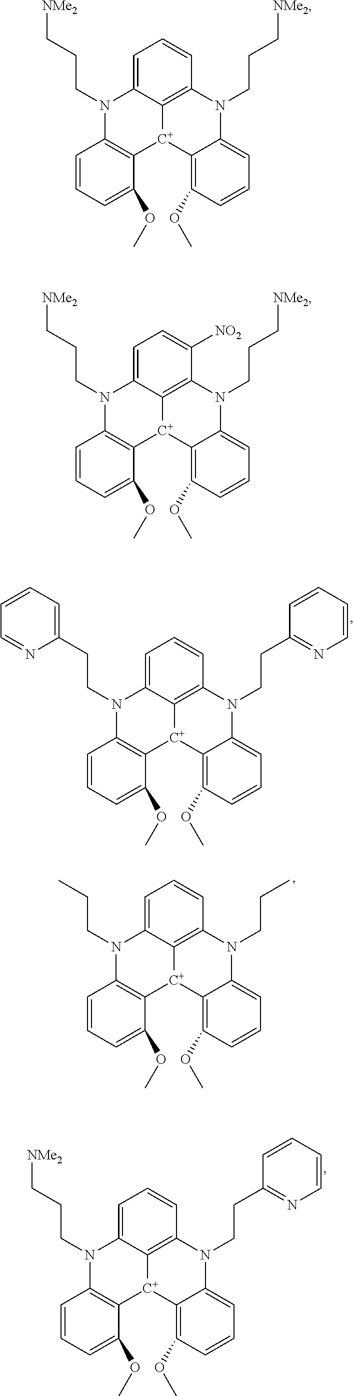

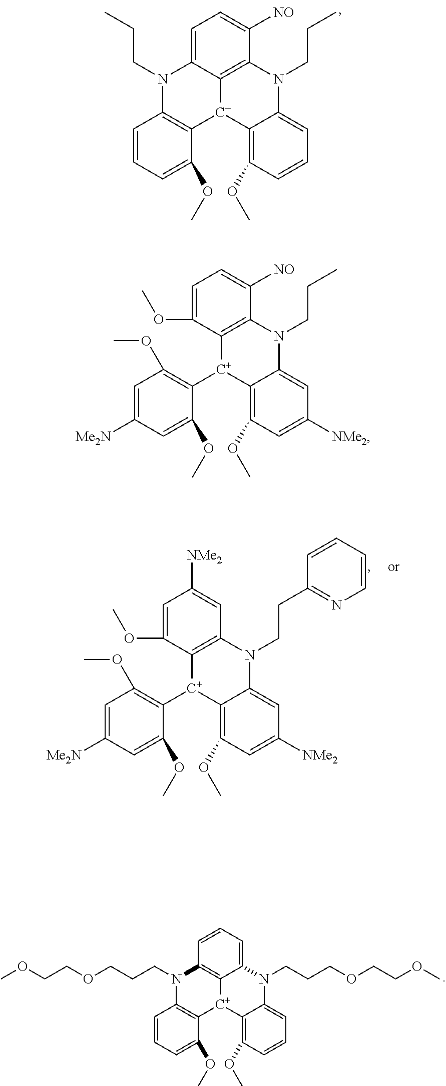

The compounds of Formula I described herein further include a counteranion. Exemplary counter anions of carbocation of Formula I include, but are not limited to, any anion including, but not limited to, halides (e.g., Cl, F, I, and Br), an anion derived from organic compounds such as carboxylates, phosphates, sulfates, etc. In some embodiments, the compound of formula I further includes an anion selected from tetrafluoroborate, hexafluorophosphate, perchlorate, tetrarylborate, trifluoromethanesulfonate, oxalatoborate, oxalate, phosphate, bis-trifluoromethanesulfonimide, halide, anion of an ionic liquid, hydroxide, carbonate, bicarbonate, sulfate, hydrogen sulfate, sulfite; or a mixture of any two or more thereof. In some embodiments, the compound of formula I further comprises an anion selected from tetrafluoroborate, hexafluorophosphate, or a mixture of any two or more thereof.

In some embodiments, Z and Z¹ are each independently a moiety including a conjugated heterocyclic carbenium. The moiety including the conjugated heterocyclic carbenium may be a compound of Formula I, including compounds of Formula Ia, Ib, and Ic as described herein. In some instances, when Z and Z¹ are each independently a moiety including a conjugated heterocyclic carbenium, the resulting compound is a compound that includes two or more conjugated heterocyclic carbeniums. For instance, a compound of Formula Tb may be covalently linked by a arylene, alkylene, or heteroalkylene linker to another compound of Formula Tb, or a compound of Formula Ic covalently linked by a arylene, alkylene, or heteroalkylene linker to another compound of Formula Ic.

In some embodiments, the redox flow battery, such as any one of the redox flow batteries described herein, further includes a separator positioned between the anolyte and the catholyte. In some embodiments, the separator is a porous membrane. In some embodiments, the redox flow battery further comprises a solvent and an electrolyte salt.

Provided in another aspect is a redox flow battery including a catholyte reservoir containing a catholyte precursor; an anolyte reservoir containing an anolyte precursor; and an ion exchange membrane comprising a first face and an opposing second face.

Any one of the redox flow battery described herein may further include an electrolyte salt. In some embodiments, the electrolyte salt is a lithium, sodium, potassium, ammonium, or alkylammonium salt of tetrafluoroborate, hexafluorophosphate, perchlorate, tetrarylborate, trifluoromethanesulfonate, oxalatoborate, oxalate, phosphate, bis-trifluoromethanesulfonimide, halide; or a mixture of any two or more thereof. In some embodiments, the electrolyte is an alkylammonium salt of tetrafluoroborate, hexafluorophosphate, perchlorate, tetrarylborate, trifluoromethanesulfonate, oxalatoborate, oxalate, phosphate, bis-trifluoromethanesulfonimide, halide; or a mixture of any two or more thereof. In some embodiments, the alkylammonium salt is a tetrabutylammonium salt, tetraethylammonium salt, or a mixture thereof. In some embodiments, the electrolyte salt is tetrabutylammonium hexafluorophosphate, tetrabutylammonium tetrafluoroborate, tetraethylammonium tetrafluoroborate, or a mixture of any two or more thereof.

Any one of the redox flow battery described herein may further include a solvent. In some embodiments, the solvent comprises a nitrile solvent, such as acetonitrile; an ether solvent, such as tetrahydrofuran; dimethylformamide; water; a halogenated solvent, such as dichloromethane; sulfolane; γ-valerolactone; or an ionic liquid.

The redox flow battery systems described herein may include any type of anodes, cathodes, and separators known to one of skilled in the art. Furthermore, the redox flow battery systems described herein may also be used for energy discharge and/or energy storage.

In any of the embodiments described herein, the redox flow battery system is a symmetric organic reverse flow battery (SORFB). In some embodiments, the separator or exchange membrane is a porous membrane. Illustrative examples of a porous membrane include but are not limited to Celgard® 2500, a porous membrane in polypropylene with a porosity of about 55%, a thickness of about 25 μm, and a pore size (average diameter) of about 0.064 μm, and Daramic® HD plus, a porous membrane having a porosity of about 55% and a thickness of about 175 μm. In some embodiments, the porous membrane is Celgard® 2500. In some embodiments, the porous membrane is a porous membrane in polypropylene having one or more of the following features: a porosity of at least about 55%, a thickness of at least about 25 μm, and a pore size (average diameter) of at least about 0.064 μm. In some embodiments, the porous membrane is a porous membrane in polypropylene having one or more of the following features: a porosity of about 55%, a thickness of about 25 μm, and a pore size (average diameter) of about 0.064 μm. In some embodiments, the porous membrane is Daramic® HD plus. In some embodiments, the porous membrane has one or more of the following features: a porosity of at least about 55% and a thickness of at least about 175 μm. In some embodiments, the porous membrane has one or more of the following features: a porosity of about 55% and a thickness of about 175 μm.

In some embodiments, the separator or exchange membrane is an anionic exchange membrane (AEM). In some embodiments, the symmetric organic redox flow battery (SORFB) having a porous membrane as the exchange membrane has equivalent or better efficiency or performance than a symmetric organic redox flow battery (SORFB) having an anionic exchange membrane as the exchange membrane. Suitable examples of an anionic exchange membrane include but are not limited to a fluorinated anionic exchange membrane, such as Fumasep® FAP-450 (a fluorinated anionic exchange membrane having a conductivity in 0.5 M H₂SO₄=9-12 mS cm⁻¹, selectivity 0.1/0.5 mol/kg KCl at T=25 is 90-96%, proton transfer rate 2500-4500 μmol min⁻¹ cm⁻², and a thickness of 50 μm). In some embodiments, the fluorinated anionic exchange membrane is Fumasep® FAP-450). In some embodiments, the fluorinated anionic exchange membrane has one or more of the following features: a conductivity in 0.5 M H₂SO₄=9-12 mS cm⁻¹, selectivity 0.1/0.5 mol/kg KCl at T=25 is 90-96%, proton transfer rate 2500-4500 μmol min⁻¹ cm⁻², and a thickness of 50 μm.

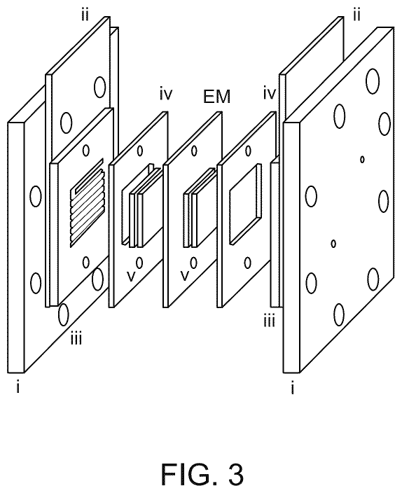

FIG. 3 shows a prototype of a small non-aqueous organic redox flow battery prepared from a commercially available electrochemical cell and components. The RFB cell is a no-gap architecture sold by Fuel Cell Technologies, Inc., composed of two metal plates (i), two gold-plated current collector (ii), two POCO® graphite serpentin bipolar electrode (iii), two Teflon gasket (iv), two graphite-felt (v; Sigracet 29 AA) with an area of 5 cm², and EM one porous membrane.

### EXAMPLES

### Example 1

The method for regenerating redox flow battery systems comprising conjugated heterocyclic carbenium compounds as both the anolyte and catholyte in accordance to this disclosure was evaluated under the following conditions. The constant current with constant voltage galvanostatic cycling with potential limitation was at 12.41V regardless of the direction of polarity for a 100% SOC limitation. The below carbenium was used:

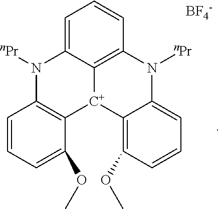

The used carbenium was at 1 mM in 0.1M TBAPF₆ CH₃CN solution, 4 mL of anolyte and 4 mL of catholyte, and flowed at 8 mL/min each at 298K.

20 cycles were at an intensity of 30 C-rate in a first direction of polarity, then the polarity was reversed for a single cycle at 5 C-rate of intensity. This cycle was followed by a restoration of the initial polarity at 30 C-rate.

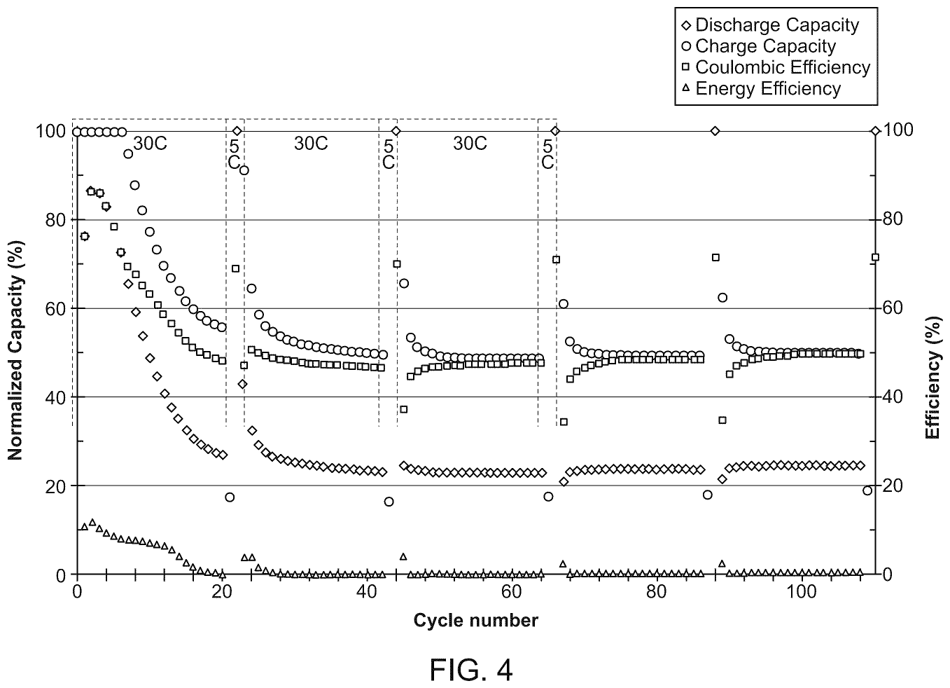

FIG. 4 shows the monitoring of the regeneration experiment by reversing the polarity during 110 cycles. 20 cycles at 30 C followed by a cycle in reverse polarity at 5 C, then restoration of the initial polarity at 30 C.

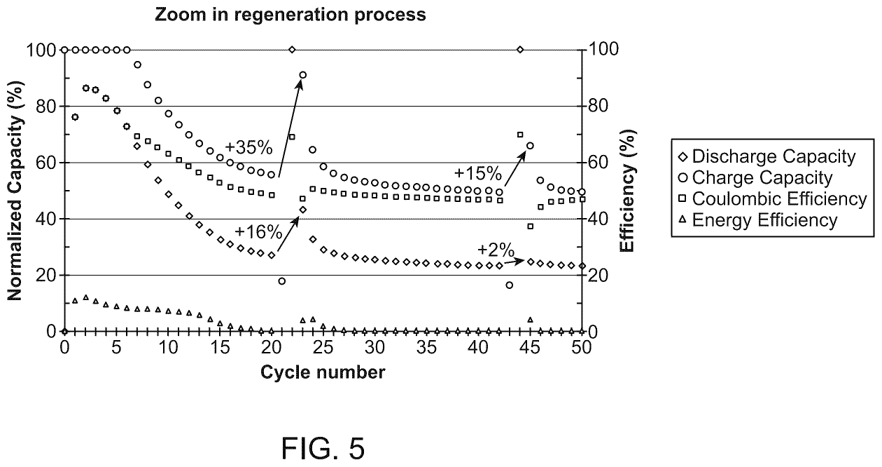

FIG. 5 shows the focus on the first 50 cycles of regeneration experiment. Polarity reversal after cycles 21 and 43 is characterized by capacity regeneration in cycles 22 and 44 of the RFB system in flow.

Para. 1. A method of regenerating a symmetrical redox flow battery, the method comprising:
a first discharge process having a duration in which a capacity of the redox flow battery in a first polarity and comprising a membrane decreases from a first capacity to a second capacity, the process comprising:
   flowing a catholyte through a catholyte compartment of the redox flow battery in the first polarity;
   flowing an anolyte through an anolyte compartment of the redox flow battery in the first polarity;
   wherein:
      the first polarity of the redox flow battery comprises the membrane having a first face in fluid communication with the catholyte compartment and a second face in fluid communication with the anolyte compartment; and
      the first and the second faces of the membrane being opposing surfaces of the membrane; and
a second discharge process comprising:
   reversing the polarity of the catholyte and anolyte compartments to a second polarity with respect to the membrane, such that the catholyte compartment is in fluid communication with the second face of the membrane, and the anolyte compartment is in fluid communication with the first face of the membrane; and
   flowing the catholyte through the catholyte compartment of the redox flow battery in the second polarity; and
   flowing the anolyte through the anolyte compartment of the redox flow battery in the second polarity;
   wherein:
      the redox flow battery in the second polarity exhibits an initial increased capacity compared to the second capacity from the first discharge process.

Para. 2. The method of Para. 1, wherein after determining a reduction in capacity during the second discharge process, reversing the second polarity to a third polarity, which is the same as the first polarity with respect to the catholyte and anolyte compartment, and subjecting the redox flow battery to a third discharge process where the initial capacity of the third discharge process is greater than the reduced capacity obtained after the second discharge process.

Para. 3. The method of Paras. 1 or 2, wherein the catholyte comprises an oxidized form of a compound and the anolyte comprises the reduced form of the compound.

Para. 4. The method of any one of Paras. 1-3, further comprising further successive discharge processes by continued reversing of the polarity of the catholyte and anolyte compartments with respect to the membrane.

Para. 5. The method of any one of Paras. 1-4, wherein:
the catholyte comprises a radical dication of a compound of Formula I; and
the anolyte comprises a neutral radical of a compound of Formula I;
wherein the compound of Formula (I) is represented by the following structure:

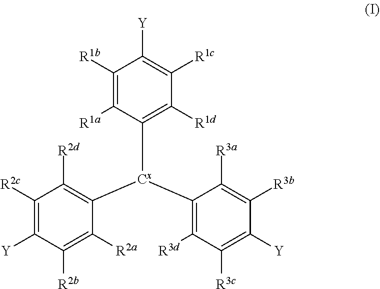

wherein:
   x is from −4 to +4;
   each of R^{1a}, R^{1b}, R^{1c}, R^{1d}, R^{2a}, R^{2b}, R^{2c}, R^{2d}, R^{3a}, R^{3b}, R^{3c}, and R^{3d} is independently H, halide, CF₃, NH₂, C₁-C₁₂ alkyl, C₁-C₄ alkoxy, C₁-C₄ alkylamino, C₁-C₄ dialkyl amino, NO₂, CN, CO₂R, or Ar¹;
   or R^{2a} and R^{3d} together form —X¹—;
   or R^{1a} and R^{2d} together form —X²—;
   or R^{1d} and R^{3a} together form —X³—;
   or R^{1a} and R^{1b} together with atoms to which they are attached to form a phenyl;
   or R^{2c} and R^{2d} together with atoms to which they are attached to form a phenyl;
   each of X¹, X² and X³ is independently O, NR^{4a}, PR^{4a}, CR^{4a}R^{4b}, or SiR^{4a}R^{4b}.
   each of R^{4a} and R^{4b} is independently H, halide, CF₃, C₁-C₁₂ alkyl, C₁-C₄ alkoxy, C₁-C₄ alkylamino, C₁-C₄ dialkyl amino, Ar³, -L-Ar³, -L-Z, or -L²-Z²;
   each of Y is independently H, halide, OR^{5a}, NR^{5a}R^{5b}, PR^{5a}R^{5b}, NO₂, CN, CF₃, CO₂R, N₃, or Ar²;
   each of R^{5a}, and R^{5b} is independently H, CF₃, C₁-C₁₂ alkyl, C₁-C₄ alkoxy, C₁-C₄ alkylamino, C₁-C₄ dialkyl amino, Ar⁴, -L¹-Ar⁴, or -L¹-Z¹;
   each of L and L¹ is independently C₁-C₁₂ alkylene, C₁-C₁₂ heteroalkylene, or arylene;
   each of L² is independently C₁-C₁₂ alkylene;
   Z and Z¹ are each independently a moiety comprising conjugated heterocyclic carbenium;
   Z² is each independently —(OCH₂CH₂O)ₙCH₃;
   n is each independently 1 to 20;
   each of R is independently C₁-C₁₂ alkyl or aryl;
   Ar¹, Ar², Ar³, and Ar⁴ are each independently unsubstituted or substituted phenyl or unsubstituted or substituted heteroaryl; each of Ar¹, Ar², Ar³, and Ar⁴ is independently substituted with 0 to 5 substituents; the substituents are each independently selected from the group consisting of halide, CF₃, NH₂, C₁-C₄ alkyl, C₁-C₄ alkoxy, C₁-C₄ alkylamino, C₁-C₄ dialkyl amino, NO₂, CN, or aryl.

Para. 6. The method of Para. 5, wherein the compound of Formula I is a compound of Formula Ia, Formula Ib, or Formula Ic:

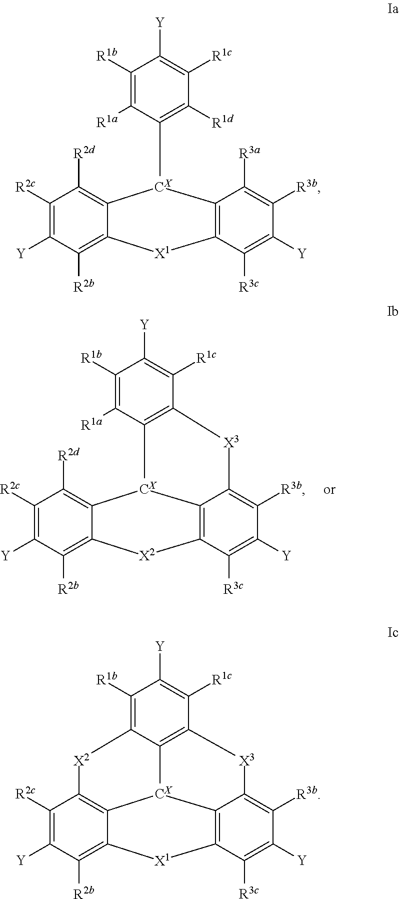

Para. 7. The method of Paras. 5 or 6, wherein each of X¹, X², and X³ is independently O or NR^{4a}.

Para. 8. The method of any one of Paras. 5-7, wherein each R^{4a} is independently C₁-C₁₂ alkyl, C₁-C₄ alkoxy, C₁-C₄ alkylamino, C₁-C₄ dialkyl amino, Ar³, -L-Ar³, -L-Z, or -L²-Z².

Para. 9. The method of any one of Paras. 5-8, wherein each R^{4a} is independently methyl, ethyl, propyl, butyl, pentyl, hexyl, —(CH₂)—N(Me)₂, —(CH₂)₂—N(Me)₂, —(CH₂)₃—N(Me)₂, —(CH₂)₃—N(Me)₂, —(CH₂)₄—N(Me)₂, —(CH₂)₂—Ar³, —(CH₂)₃—Ar³, —(CH₂)₃—Ar³, —(CH₂)₄—Ar³, —(CH₂)—(OCH₂CH₂O)CH₃, —(CH₂)₂—(OCH₂CH₂O)CH₃, —(CH₂)₃—(OCH₂CH₂O)CH₃, or —(CH₂)₄—(OCH₂CH₂O)CH₃; Ar³ is 2-pyridinyl.

Para. 10. The method of Para. 6, wherein the compound of Formula Ib is a compound, wherein:
X² and X³ are each NR^{4a};
each R^{4a} is independently C₁-C₁₂ alkyl, C₁-C₄ dialkyl amino, -L-Ar³, or -L²-Z²;
R^{1a} and R^{2d} are each C₁-C₄ alkoxy;
each of R^{1b}, R^{1c}, R^{2b}, R^{2c}, R^{3b}, and R^{3c} is independently H, C₁-C₄ alkylamino, or NO₂;
each of Y is independently H, NO₂, or NR^{5a}R^{5b}; and
each of R^{5a} and R^{5b} is independently H, CF₃, or C₁-C₁₂ alkyl.

Para. 11. The method of Para. 5, wherein the compound of Formula I is a compound of any one of the following:

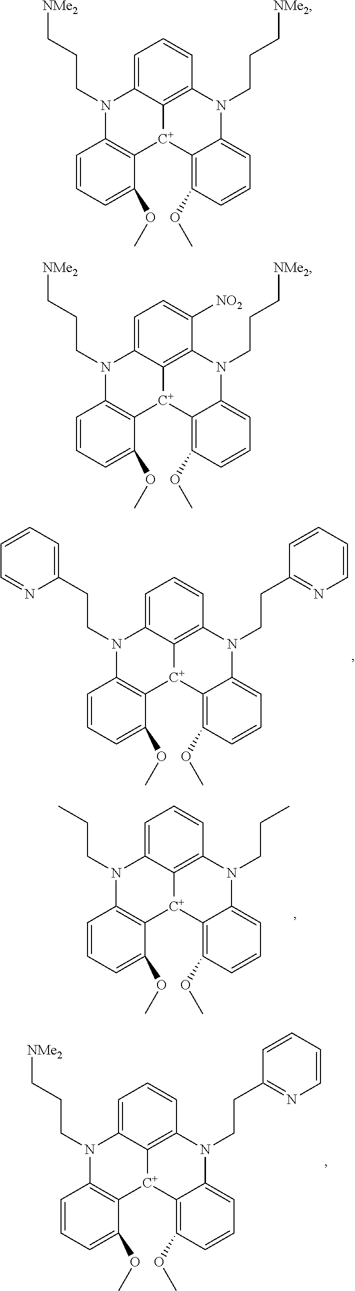

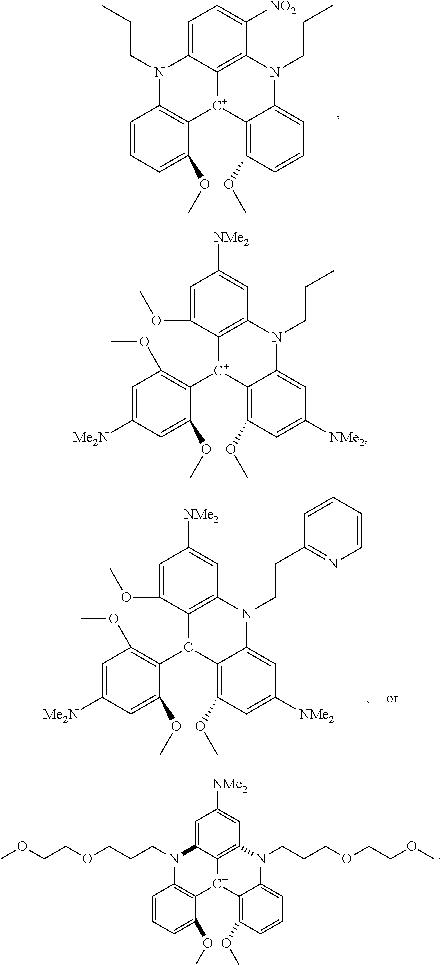

Para. 12. The method of any one of Paras. 5-11, wherein the compound of formula I further comprises an anion selected from tetrafluoroborate, hexafluorophosphate, perchlorate, tetrarylborate, trifluoromethanesulfonate, oxalatoborate, oxalate, phosphate, bis-trifluoromethanesulfonimide, halide, anion of an ionic liquid, hydroxide, carbonate, bicarbonate, sulfate, hydrogen sulfate, sulfite; or a mixture of any two or more thereof.

Para. 13. A method of charging a symmetrical redox flow battery, the method comprising:
providing a redox flow battery comprising:
   a catholyte reservoir containing a catholyte precursor;
   an anolyte reservoir containing an anolyte precursor;
   an ion exchange membrane comprising a first face and an opposing second face; and
applying an oxidizing potential to the catholyte precursor in the catholyte reservoir to generate a catholyte;
applying a reducing potential to the anolyte precursor in the anolyte reservoir to generate an anolyte;
wherein:
   the anolyte precursor is the same as the catholyte precursor; and
   the first face of the ion exchange membrane is in fluid communication with the catholyte; and
   the second face of the ion exchange membrane is in fluid communication with the anolyte.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

What is claimed is:

1. A method of regenerating a symmetrical redox flow battery, the method comprising:
a first discharge process having a duration in which a capacity of the redox flow battery in a first polarity and comprising a membrane decreases from a first capacity to a second capacity, the process comprising:
flowing a catholyte through a catholyte compartment of the redox flow battery in the first polarity;
flowing an anolyte through an anolyte compartment of the redox flow battery in the first polarity;
wherein:
the first polarity of the redox flow battery comprises the membrane having a first face in fluid communication with the catholyte compartment and a second face in fluid communication with the anolyte compartment; and
the first and the second faces of the membrane being opposing surfaces of the membrane; and
a second discharge process comprising:
reversing the polarity of the catholyte and anolyte compartments to a second polarity with respect to the membrane, such that the catholyte compartment is in fluid communication with the second face of the membrane, and the anolyte compartment is in fluid communication with the first face of the membrane; and
flowing the catholyte through the catholyte compartment of the redox flow battery in the second polarity; and
flowing the anolyte through the anolyte compartment of the redox flow battery in the second polarity;
wherein:
the redox flow battery in the second polarity exhibits an initial increased capacity compared to the second capacity from the first discharge process.

2. The method of claim 1, wherein after determining a reduction in capacity during the second discharge process, reversing the second polarity to a third polarity, which is the same as the first polarity with respect to the catholyte and anolyte compartment, and subjecting the redox flow battery to a third discharge process where the initial capacity of the third discharge process is greater than the reduced capacity obtained after the second discharge process.

3. The method of claim 1, wherein the catholyte comprises an oxidized form of a compound and the anolyte comprises the reduced form of the compound.

4. The method of claim 1 further comprising further successive discharge processes by continued reversing of the polarity of the catholyte and anolyte compartments with respect to the membrane.

5. The method of claim 1, wherein:
the catholyte comprises a radical dication of a compound of Formula I; and
the anolyte comprises a neutral radical of a compound of Formula I;
wherein the compound of Formula (I) is represented by the following structure: 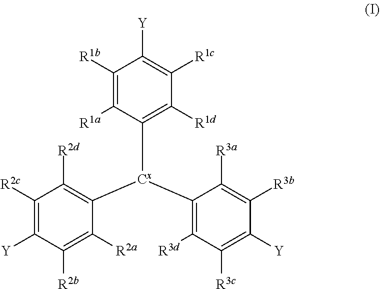
wherein:
x is from −4 to +4;
each of R^{1a}, R^{1b}, R^{1c}, R^{1d}, R^{2a}, R^{2b}, R^{2c}, R^{2d}, R^{3a}, R^{3b}, R^{3c}, and R^{3d} is independently H, halide, CF₃, NH₂, C₁-C₁₂ alkyl, C₁-C₄ alkoxy, C₁-C₄ alkylamino, C₁-C₄ dialkyl amino, NO₂, CN, CO₂R, or Ar¹;
or R^{2a} and R^{3d} together form —X¹—;
or R^{1a} and R^{2d} together form —X²—;
or R^{1d} and R^{3a} together form —X³—;
or R^{1a} and R^{1b} together with atoms to which they are attached to form a phenyl;
or R^{2c} and R^{2d} together with atoms to which they are attached to form a phenyl;
each of X¹, X² and X³ is independently O, NR^{4a}, PR^{4a}, CR^{4a}R^{4b}, or SiR^{4a}R^{4b};
each of R^{4a} and R^{4b} is independently H, halide, CF₃, C₁-C₁₂ alkyl, C₁-C₄ alkoxy, C₁-C₄ alkylamino, C₁-C₄ dialkyl amino, Ar³, -L-Ar³, -L-Z, or -L²-Z²;
each of Y is independently H, halide, OR^{5a}, NR^{5a}R^{5b}, PR^{5a}R^{5b}, NO₂, CN, CF₃, CO₂R, N₃, or Ar²;
each of R^{5a}, and R^{5b} is independently H, CF₃, C₁-C₁₂ alkyl, C₁-C₄ alkoxy, C₁-C₄ alkylamino, C₁-C₄ dialkyl amino, Ar⁴, -L¹-Ar⁴, or -L¹-Z¹;
each of L and L¹ is independently C₁-C₁₂ alkylene, C₁-C₁₂ heteroalkylene, or arylene;
each of L² is independently C₁-C₁₂ alkylene;
Z and Z¹ are each independently a moiety comprising conjugated heterocyclic carbenium;
Z² is each independently —(OCH₂CH₂O)ₙCH₃;
n is each independently 1 to 20;
each of R is independently C₁-C₁₂ alkyl or aryl;
Ar¹, Ar², Ar³, and Ar⁴ are each independently unsubstituted or substituted phenyl or unsubstituted or substituted heteroaryl; each of Ar¹, Ar², Ar³, and Ar⁴ is independently substituted with 0 to 5 substituents; the substituents are each independently selected from the group consisting of halide, CF₃, NH₂, C₁-C₄ alkyl, C₁-C₄ alkoxy, C₁-C₄ alkylamino, C₁-C₄ dialkyl amino, NO₂, CN, or aryl.

6. The method of claim 5, wherein the compound of Formula I is a compound of Formula Ia, Formula Ib, or Formula Ic:

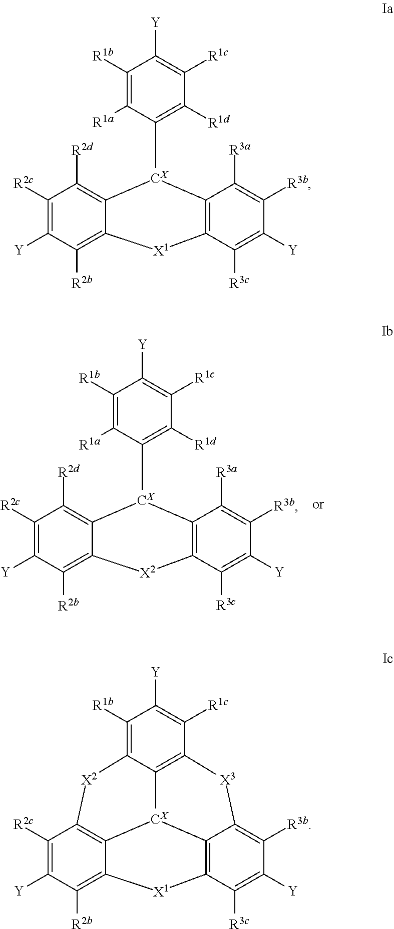

7. The method of claim 5, wherein each of X¹, X², and X³ is independently O or NR^{4a}.

8. The method of claim 7, wherein each R^{4a} is independently C₁-C₁₂ alkyl, C₁-C₄ alkoxy, C₁-C₄ alkylamino, C₁-C₄ dialkyl amino, Ar³, -L-Ar³, -L-Z, or -L²-Z².

9. The method of claim 8, wherein each R^{4a} is independently methyl, ethyl, propyl, butyl, pentyl, hexyl, —(CH₂)—N(Me)₂, —(CH₂)₂—N(Me)₂, —(CH₂)₃—N(Me)₂, —(CH₂)₃—N(Me)₂, —(CH₂)₄—N(Me)₂, —(CH₂)₂—Ar³, —(CH₂)₃—Ar³, —(CH₂)₃—Ar³, —(CH₂)₄—Ar³—(CH₂)—(OCH₂CH₂O)CH₃, —(CH₂)₂—(OCH₂CH₂O)CH₃, —(CH₂)₃—(OCH₂CH₂O)CH₃, or —(CH₂)₄—(OCH₂CH₂O)CH₃; Ar³ is 2-pyridinyl.

10. The method of claim 6, wherein the compound of Formula Ib is a compound, wherein:
X² and X³ are each NR^{4a};
each R^{4a} is independently C₁-C₁₂ alkyl, C₁-C₄ dialkyl amino, -L-Ar³, or -L²-Z²;
R^{1a} and R^{2d} are each C₁-C₄ alkoxy;
each of R^{1b}, R^{1c}, R^{2b}, R^{2c}, R^{3b}, and R^{3c} is independently H, C₁-C₄ alkylamino, or NO₂;
each of Y is independently H, NO₂, or NR^{5a}R^{5b}; and
each of R^{5a} and R^{5b} is independently H, CF₃, or C₁-C₁₂ alkyl.

11. The method of claim 5, wherein the compound of Formula I is a compound of any one of the following:

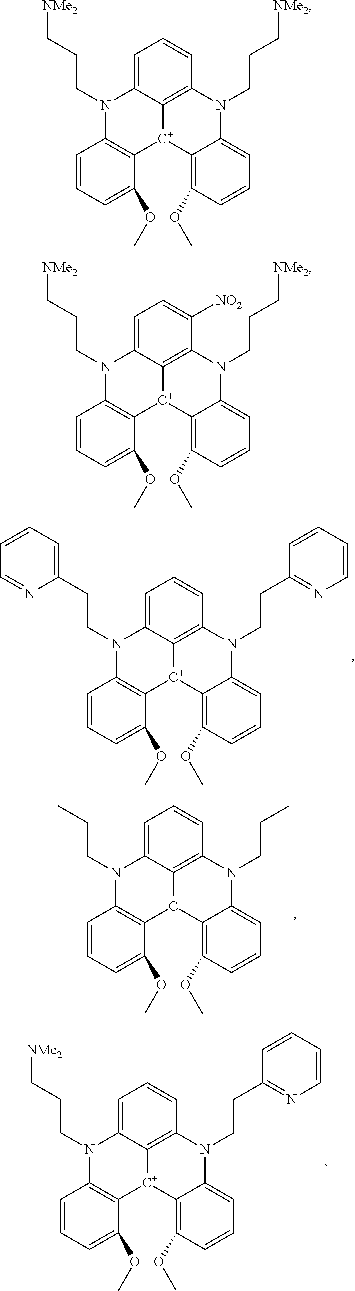

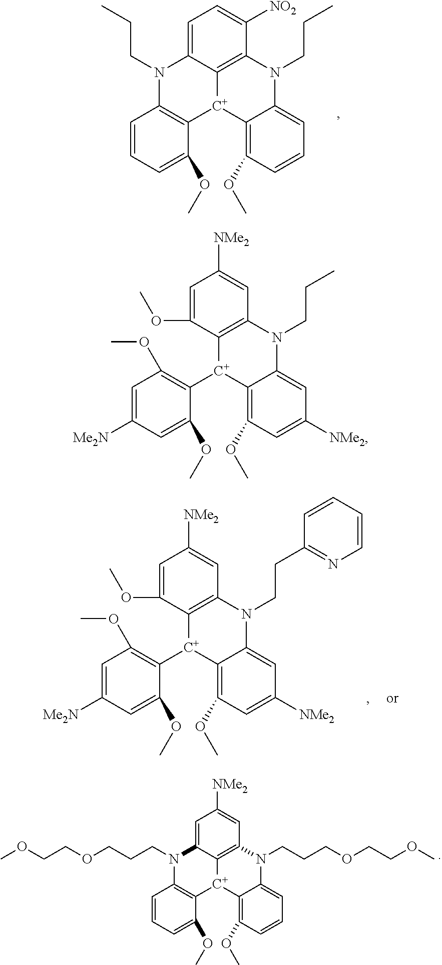

12. The method of claim 5, wherein the compound of formula I further comprises an anion selected from tetrafluoroborate, hexafluorophosphate, perchlorate, tetrarylborate, trifluoromethanesulfonate, oxalatoborate, oxalate, phosphate, bis-trifluoromethanesulfonimide, halide, anion of an ionic liquid, hydroxide, carbonate, bicarbonate, sulfate, hydrogen sulfate, sulfite; or a mixture of any two or more thereof.

13. A method of charging a symmetrical redox flow battery, the method comprising:
providing a redox flow battery comprising:
a catholyte reservoir containing a catholyte precursor;
an anolyte reservoir containing an anolyte precursor;
an ion exchange membrane comprising a first face and an opposing second face; and
applying an oxidizing potential to the catholyte precursor in the catholyte reservoir to generate a catholyte;
applying a reducing potential to the anolyte precursor in the anolyte reservoir to generate an anolyte;
wherein:
the anolyte precursor is the same as the catholyte precursor; and
the first face of the ion exchange membrane is in fluid communication with the catholyte; and
the second face of the ion exchange membrane is in fluid communication with the anolyte.
